(19) United States
(12) Patent Application Publication
(10) Pub. No.: US 2023/0256640 A1
(43) Pub. Date: Aug. 17, 2023

(54) CONTROL SYSTEMS FOR POWER TOOLS

(71) Applicant: SawStop Holding LLC, Tualatin, OR (US)

(72) Inventors: Louis R. Slamka, Vancouver, WA (US); Jeremy C. Espinosa, Dallas, TX (US); Tyler S. Howell, Keizer, OR (US); Paul H. Stasiewicz, Oregon City, OR (US); Brian M. Unger, Hillsboro, OR (US)

(73) Assignee: SawStop Holding LLC, Tualatin, OR (US)

(21) Appl. No.: 18/005,432

(22) PCT Filed: Jul. 13, 2021
(86) PCT No.: PCT/US2021/041394

§ 371 Date: Jan. 13, 2023

Related U.S. Application Data
(60) Provisional application No. 63/051,402, filed on Jul. 14, 2020.

(51) Int. Cl. B26D 7/24; G05B 19/18

(52) U.S. Cl. CPC B26D 7/24; G05B 19/182; B27G 19/02

(57) ABSTRACT

Control systems to control the operation of a power tool are disclosed. The disclosed control systems are particularly, but not exclusively, applicable to power tools with active injury mitigation technology, and to table saws with active injury mitigation technology, such as jobsite and benchtop table saws. The improved systems, for example, control the supply of power to a motor, enhance reliability, provide redundant safety features, and help to prevent the motor from starting unexpectedly.

### CROSS-REFERENCE TO RELATED APPLICATIONS

This application is a continuation of International Application No. PCT/US2021/41394, filed Jul. 13, 2021, which claims the benefit of and priority from U.S. Provisional Patent Application Ser. No. 63/051,402, filed Jul. 14, 2020, which is incorporated herein by reference.

### TECHNICAL FIELD

The present specification relates to control systems for power tools such as table saws, miter saws, band saws, hand-held circular saws, jointers, shapers, routers, up-cut saws and other machinery.

### BACKGROUND

Power tools such as table saws, miter saws, band saws, hand-held circular saws, jointers, shapers, routers, and up-cut saws are used to cut and shape material. In most power tools a user simply flips a switch to start the tool. The switch closes a circuit so that electric current flows through the switch to a motor, and the motor moves a blade or cutter.

Power tools with active injury mitigation technology are controlled differently. Active injury mitigation technology refers to technology that detects contact or proximity between a person and a spinning blade or cutter, and then performs some predetermined action to mitigate injury, such as stopping and/or retracting the blade or cutter. Exemplary implementations of active injury mitigation technology are described in International Patent Application Publication No. WO 01/26064 A2, which is incorporated herein by reference. In tools equipped with active injury mitigation technology, a user also flips a switch to start the tool, but electric current does not typically flow through the switch to a motor. Instead, the switch requests or signals a microprocessor to start the motor, and the microprocessor then does so, provided any other conditions monitored by the microprocessor are satisfied.

This specification describes improved systems to control the operation of a power tool. The improved systems are particularly, but not exclusively, applicable to power tools with active injury mitigation technology. The improved systems, for example, control the supply of power to a motor, enhance reliability, provide redundant safety features and help to prevent the motor from starting unexpectedly.

### BRIEF DESCRIPTION OF THE DRAWINGS

FIG. 1 shows a schematic view of a power tool.

FIG. 2 shows a schematic view of a power tool with active injury mitigation technology.

FIG. 3 shows a motor relay control circuit.

FIG. 4 shows a circuit with a latch for receiving input signals from a user and outputting relay control signals.

FIG. 5 shows a perspective view of a table saw with a switch box.

FIG. 6 shows a close-up perspective view of a switch box.

FIG. 7 shows a partial cut-away, cross-sectional, side view of a motor Start/Stop switch in the OFF position.

FIG. 8 shows a partial cut-away, cross-sectional, side view of a motor Start/Stop switch in the ON position.

FIG. 9. shows a partial cut-away, exploded, perspective view of a bypass key switch.

FIG. 10 shows a partial cut-away, perspective view of a bypass key switch in the OFF position.

FIG. 11 shows a partial cut-away, perspective view of a bypass key switch in the ON position.

FIG. 12 shows a perspective view of a switch box with a bypass key switch in the lock-out position.

### STATEMENTS CONCERNING THIS DISCLOSURE

The present disclosure describes various exemplary embodiments of control systems, power tools, components, circuits, and processes. The embodiments as disclosed and illustrated herein are not to be considered in a limiting sense as numerous variations are possible. Rather, the various exemplary embodiments depicted in the drawings and described in detail below are intended to illustrate specific examples and implementations in a variety of different contexts. It will be understood by those of skill in the art that many different variations, modifications, alternatives, and equivalents of these particular exemplary embodiments are possible. Therefore, the drawings and detailed description are not intended to limit the scope of the claims to the forms, arrangements, components, and/or configurations depicted and described therein. Instead, the drawings and detailed description are intended to cover all such variations, modifications, alternatives, and equivalents as are described and suggested within the scope and spirit of the disclosure and as are defined by the claims.

While references to “exemplary embodiment”, “alternative embodiments”, “other embodiments”, etc., may appear throughout the disclosure, repeated occurrences of such references are not intended necessarily to refer to the same embodiment(s). Rather, such references should be understood in the context in which they are provided and with reference to the figures and components with which they are associated within the narrative of the disclosure. Furthermore, reference to certain embodiments is not intended to exclude other embodiments since particular components, elements, circuits, structures, assemblies, processes, and methods described herein may be combined and/or modified in any manner that is suitable and consistent with the disclosure.

This disclosure may sometimes refer to structural elements as being “configured to,” or “adapted to,” perform one or more tasks, operations, or functions. Such elements may be referred to as “components,” “circuits,” “assemblies,” “mechanisms,” etc. It should be understood that when such an element is described as being “configured to” or “adapted to” perform such a task or etc., this phrasing is intended to refer to a physical object or structure such as an electronic component (e.g., resistor, capacitor, cable, processor, etc.), or a mechanical component (e.g., arm, bracket, shaft, mount, housing, etc.), or a plurality of such components interconnected or combined into a circuit, mechanism or assembly. Furthermore, the phrasing “configured to” or “adapted to” perform a particular task or etc., is intended to indicate that the structural component or combination of components is arranged, positioned, selected, programmed, connected, combined and/or designed to perform the particular function stated. Thus, for example, the phrase “a processor component configured to receive an input from a user-input component” means a physical processor with one or more input nodes which may be connected either directly, or indirectly through additional circuit components, to the output of a physical switch, button, knob or similar component which is operable by a person to produce electrical signals. And further that the input node(s) of the processor are capable of receiving signals of the type which the user-input component produces, so that the processor, while executing software instructions stored in memory is capable of recognizing the signal for its intended purpose and executing further instructions in response to the signal as determined by the stored software. Likewise, the phrase “a motor configured to drive the cutting tool” means a motor with sufficient output power to move the cutting tool in a manner and at a speed appropriate for the corresponding power tool to cut or shape workpieces as intended. Therefore, it should be understood that all references herein of some particular element being “configured to” or “adapted to” perform some operation, task, or function refers to a physical object and not to some intangible entity, process, or function.

In addition, the term “configured to” or “adapted to” does not mean “configurable to” or “adaptable to.” Thus, for example, an unprogrammed processor that is devoid of executable software instructions may be configurable to perform a task, but it cannot be considered as “configured to” perform the task. Instead, if a processor is referred to herein as “configured to” perform a task, that means the processor includes the necessary executable software instructions, as well as any necessary processing functionality such as analog-to-digital conversion or etc., to perform the referenced task.

To the extent the phrase “in response to” is used herein, the phrase is intended to describe one more factors that produce an effect. However, the phrase is not intended to eliminate the possibility that additional and/or different factors may affect whether or how the effect is produced. Thus, for example, the phrase “the control circuit is configured to start the motor in response to inputs by the operator” does not mean that the input from the operator is necessarily the only input or condition necessary to start the motor. Instead, the phrase is intended to cover the situation where the motor is started solely in response to input by the operator, as well as the situation where the motor is started only when one or more additional conditions or inputs are present in combination with the input by the operator. Furthermore, the phrase is also not intended to convey that the motor can only be started in response to the input from the operator, as other conditions and/or inputs may also cause the motor to start independent of the input from the operator.

If used herein, the terms “first,” “second,” etc., when used to modify structural elements, are not intended to describe any temporal or spatial order or priority, unless such order or priority is expressly stated. Thus, for example, the terms “first processor” and “second processor” do not, unless otherwise stated, imply that the component referred to as the “first processor” has any priority or control over the component referred to as the “second processor.” Furthermore, the terms are not intended to imply that the two processors are either identical or non-identical unless explicitly described as such. Instead, the terms are solely intended to convey the presence of two, separate physical processors.

Unless otherwise stated explicitly, the terms “user” and “operator,” when used herein in reference to using or operating a mechanism such as a power tool, are identical and interchangeable. In contrast, the term “person” means any person whether or not the person is using or operating the mechanism in question.

In the drawings and description herein, numerous specific details are disclosed for a variety of exemplary embodiments to provide a complete and thorough understanding to those of skill in the art. Nevertheless, those of skill in the art will recognize that many aspects of the present disclosure can be practiced without one or more of the specific details. In some embodiments, well-known and/or readily available components, circuits, structures, assemblies, signals, software instructions, and techniques may have not been shown in detail to avoid unhelpful complexity which might hinder comprehension of the present disclosure in its entirety.

### DETAILED DESCRIPTION

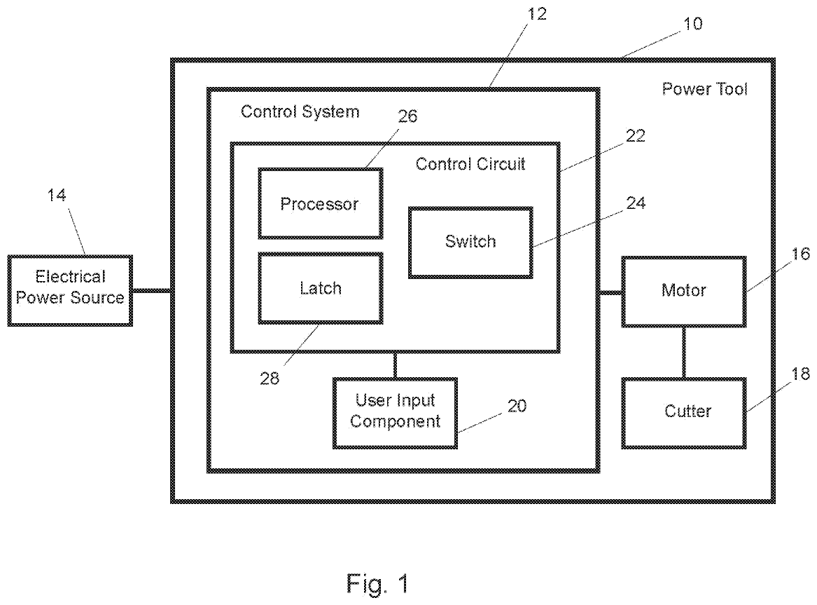

One embodiment of a power tool according to the present invention is shown schematically at 10 in FIG. 1. It will be understood by those of skill in the art that power tool 10 can be any of a wide variety of well-known electro-mechanical devices designed to process workpieces of various materials. As used herein, woodworking machinery describes power tools designed primarily to cut wood, although woodworking machinery is sometimes used to cut other materials such as plastic and aluminum. Some common examples of woodworking machinery are table saws, band saws, miter saws, hand-held circular saws, up-cut saws, jointers, routers, shapers, etc.

Power tool 10 includes a control system 12 which enables a user or operator to control or operate one or more functions of the power tool. In the exemplary embodiment of FIG. 1, the control system is configured to connect to a source of electrical power 14 and to start and stop an electrically-driven motor 16 which drives or moves a cutting tool such as cutter 18. The electrical power source is typically provided by electrical wiring connecting the power tool to a local source of power, indicated at 14, such as an electric utility, an electric generator, a battery, or etc. The motor may be any of the well-known types of motors suitable for use in a power tool including, induction motors, universal motors, DC motors, brushless motors, etc. The cutting tool may be any of the well-known components adapted for cutting workpieces such as blades, bits, chippers, shapers, etc.

Control systems for power tools may be as simple as an ON/OFF switch to connect and disconnect electrical power to the motor. The switch can be in any of a number of forms including buttons, levers, triggers, etc. Alternatively, the control system may be configured to allow the user to control other functions such as motor speed, cutter speed, motor direction, torque, etc. Where multiple functions are controllable through the control system, the power tool may include multiple components such as buttons, knobs, switches, keypads, keyboards, etc. with which the user can operate the power tool. Control systems may include one or more electrical circuits to sense, monitor and or control the various conditions and functions of the power tool. In some embodiments, the control system may include one or more processors that are programmed with software or code to manage and/or assist in the operation and control of the power tool.

In the exemplary embodiment of FIG. 1, control system 12 includes a user input component 20 which is connected or coupled to a control circuit 22. User input component is operable by a user to send a signal to the control circuit to start and stop motor 16. In one embodiment, user input component 20 is in the form of an ON/OFF button which the user pulls out to signal that the user wants to start the motor. Likewise, the user pushes in the button in to signal that the user wants to stop the motor. It will be understood that the input component could alternatively be a flip switch or knob or any of a large variety of user operable components or mechanisms which are well known in the art.

According to the present invention, control circuit 22 includes at least one electrical switch 24 which is adapted to transfer or conduct electrical power to motor 16. The control circuit may be configured to conduct electrical power from the electrical power source to the motor without any change or conditioning. Alternatively, the control circuit may change or condition the electrical power as suitable prior to conducting it to motor 16. In any case, the control circuit is configured to open and close switch 24 in response to signals from user input component 20. When the switch is open or in the ‘OFF’ condition electrical power cannot not transfer through the switch and the motor will either not start, or will stop if currently running. Conversely, when the switch is closed or in the ‘ON’ condition electrical power can transfer through the switch to the motor causing the motor to either continue running, or to start if currently stopped.

Control circuit 22 also includes a programmable processor 26 with stored software or code to control the operation of the processor. While a single processor is shown in the exemplary embodiment of FIG. 1, it will be appreciated that multiple processors can alternatively be used to provide additional or redundant functionality. In any case, processor 26 is coupled to receive input signals from user input component 20. The processor is also coupled to control the operation of switch 24 and thereby the operation of motor 16. The processor controls the operation of switch 24 according to the logic commands of the software with which the processor is programmed. In addition to input signals from user input component 20, the processor may also be coupled to one or more other inputs which the processor analyzes to determine its operation. It will be appreciated that many different inputs can be used to enable the processor to monitor the operation of the power tool and the environment. A few examples of such other inputs include motor speed, cutter speed, ambient temperature, amplitude and frequency of the power source, etc.

When the user input component is in the ‘OFF’ position, indicating the user wishes the motor to be stopped, the processor receives this signal as an input. According to the commands of the software, the processor would typically then send an output signal that causes switch 24 to either remain in, or transition to, the open condition. Thus, if the user pushes the ON/OFF button in while the motor is running, then the processor stops the motor by causing the switch to open.

Similarly, when the user input component is in the ‘ON’ position, indicating the user wishes the motor to start or continue running, the processor receives this signal as well. According to the commands of the software, the processor may then send an output signal that causes switch 24 to either remain in, or transition to, the closed position. Thus, if the user pulls the ON/OFF button out while the motor is stopped, then the processor may cause the switch to close depending on the logic of the software and whether other conditions must be met before the switch is closed.

It will be appreciated that in many power tools, the moving cutter can be potentially dangerous to either the user/operator or anyone near the power tool. As a result, it is important that the motor should never start unless the user specifically requests the motor to start. To ensure safety, the processor software is configured to allow electrical power to the motor only when the user input component is in the ON position and only when any other conditions are met as required by the software. For example, if the power tool or control system is unexpectedly removed from the source of electrical power, then the motor will shut down due to a lack of electrical power. In such a situation, the processor may or may not shut down depending on whether a backup source of power is present. It will be understood that a loss of electrical power to the power tool could be caused by various occurrences including a utility outage, a tripped electrical breaker, or the accidental unplugging of a power cord, etc.

In any event, if electrical power is suddenly lost while the user input component is in the ON position, a dangerous situation may occur if the user does not place the input component in the OFF position. In that case, if electrical power is suddenly restored, it would be dangerous if the motor suddenly began to run unexpectedly. To avoid this dangerous situation, the processor may be programmed to declare an error condition if the user input component is in the ON position when power is connected or restored to the power tool. In which case, the processor would maintain switch 24 in the open condition while the error persists. To clear the error, the user would be required to move the user input component to the OFF position. Once the processor received the ‘OFF’ signal from the user input component, the processor would clear the error. At which point, if the user moved the user input component to the ON position, the processor would receive that new signal and execute it in accordance with the software programming.

In many situations, it is desirable to have redundant safeguards to prevent a dangerous condition from occurring due to the failure of a single component or system. For example, if the processor is programmed as described above to prevent an unexpected motor start, then any failure of the processor or error in the software could still allow a dangerous situation to occur. Therefore, it may be desirable for the power tool to have a redundant system or component to prevent such unexpected motor starts independent of the processor.

In the exemplary embodiment of FIG. 1, control system 12 includes a latch 28 configured to prevent the processor from closing switch 24 and starting the motor if electrical power is connected or restored to the power tool while the user input component is in the ON position. The latch is configured to operate in a first or unlatched state if electrical power is connected or restored to the power tool when the user input component is in the ON position. The latch can also be thought of as operating in the “restart prevention” state in this situation since the latch will prevent the motor from restarting by preventing the processor from closing the switch.

However, if the user input component is in the OFF position when power is connected or restored to the power tool, then the latch is configured to operate in a second or latched state. Similarly, if the user input component is in the ON position when electrical power is connected or restored to the power tool, the latch is configured to switch from the unlatched state to the latched state once the user input component is moved to the OFF position. Thus, the user can start the motor by first moving the input component to the OFF position and then moving it back to the ON position. The second state of the latch can also be thought of as the “start enablement” or “restart enablement” state since the latch enables the processor to start the motor according to the processor's software commands.

As described above, the latch provides a safety function that is in addition, or redundant, to any safety functions of the processor. As a result, a failure or defect in the hardware or software of the processor will not cause an unexpected motor start. Likewise, a failure in the latch will not cause an unexpected motor start because the processor would prevent that from occurring. It will be appreciated that use of the term “latch” is not intended to specify any single or particular component, element or system. Instead, any of a variety of known components, elements, systems or assemblies thereof may be used which operate independently to prevent the motor from restarting under specified conditions, notwithstanding or irrespective of any software command or signal from the processor. One exemplary embodiment of a control system including a latch will be described in more detail below.

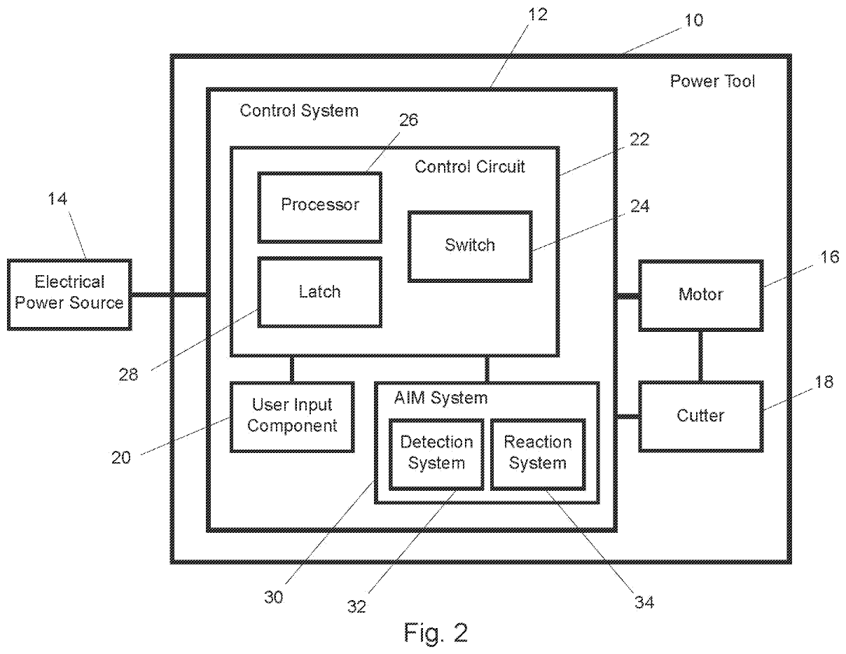

As shown in FIG. 2, alternative embodiments of power tool 10 and control system 12 may include active injury mitigation technology or an active injury mitigation system as indicated schematically at 30. As is well known in the art, active injury mitigation technology, hereinafter referred to as AIM technology or an AIM system, includes any one of a variety of known electrical and mechanical structures arranged, assembled, connected, coupled, adapted and/or configured to detect the occurrence of a potentially dangerous condition and thereupon to react or initiate a reaction to mitigate injury to a user, operator or other person in proximity to the table saw. An AIM system is different than a passive injury mitigation system, such as a blade guard, in that a passive injury mitigation system does not detect the occurrence of a potentially dangerous condition and does not react or initiate a reaction to the potentially dangerous condition. Examples of AIM systems are disclosed in International Patent Application No. PCT/US00/26812, published as International Publication No. WO 01/26064 A2 on Apr. 12, 2001, the disclosure of which is incorporated herein by reference in its entirety.

In the exemplary embodiment of FIG. 2, the AIM system incorporated in power tool 10 includes a detection system 32 configured to detect contact between a person and the saw blade when the blade is moving, and a reaction system 34 configured to either stop the blade from moving or to at least partially retract the blade below the table, or to both stop and retract the blade. It will be appreciated that by stopping the movement of the blade and/or at least partially retracting the blade, the reaction system will cause the blade to stop cutting whatever it is in contact with at the time the contact between the blade and the person is detected, thereby mitigating injury to the person.

As used herein the term detection system refers to any one of a number of well-known and extensively described assemblies of structural components including electronic and mechanical components as well as software components or software code, which are arranged, coupled and configured to detect one or more selected dangerous conditions. A few exemplary embodiments of suitable detections systems are described in more detail in International Patent Application No. PCT/US00/26812, published as International Publication No. WO 01/26064 A2 on Apr. 12, 2001, U.S. Pat. No. 7,900,541 issued Mar. 8, 2011, U.S. Pat. No. 7,971,613 issued Jul. 5, 2011, U.S. Pat. No. 8,498,732 issued Jul. 16, 2013, and International Patent Application No. PCT/US2017/034566, published as International Publication No. WO 2017/210091 A1 on Dec. 7, 2017, the disclosures of which are incorporated herein by reference in their entireties. Likewise, the term reaction system as used herein refers to any one of a number of well-known and extensively described assemblies of structural components including electronic and mechanical components which are arranged, coupled and configured to take, cause or initiate one or more selected actions to mitigate injury. Such reaction systems may also include software components or software code in some embodiments. A few exemplary embodiments of suitable reaction systems are described in more detail in International Patent Application No. PCT/US00/26812, published as International Publication No. WO 01/26064 A2 on Apr. 12, 2001, International Patent Application No. PCT/US2010/002634, published as International Publication No. WO 11/040957 on Apr. 7, 2011, U.S. Pat. No. 9,927,796 issued Mar. 27, 2018, U.S. Pat. No. 10,052,786 issued Aug. 21, 2018, and U.S. Pat. No. 10,442,107 issued Oct. 15, 2019, the disclosures of which are incorporated herein by reference in their entireties.

As discussed above, control system 12 can be configured in any of a wide variety of ways to control operation of power tool 10. The configuration of any particular control system will typically vary depending on the type of power tool it is incorporated within and the power tool functions to be monitored and controlled. For example, a control system may have one section or sub-assembly that controls operation of a motor in response to inputs from the operator, while another section controls status indicator displays to communicate the operational status of the power tool to the user. It will be appreciated that a control system may have many different sections where each section is configured to perform a different function. Examples of such other functions include, but are not limited to, active injury mitigation, operational logs, maintenance sensors and displays, power tool operational adjustments and measurements, etc. In addition, some or all of the various sections of the control system may be coupled or inter-connected with other sections to achieve a desired overall level of control and function. Therefore, it will be understood that while one exemplary section or portion of a control system is described in more detail below, the control system may also include one or more additional sections which are configured differently.

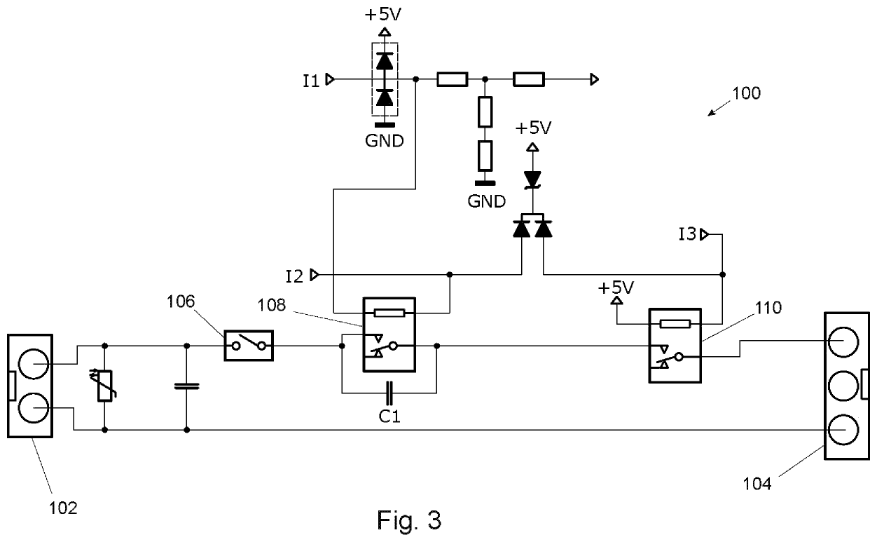

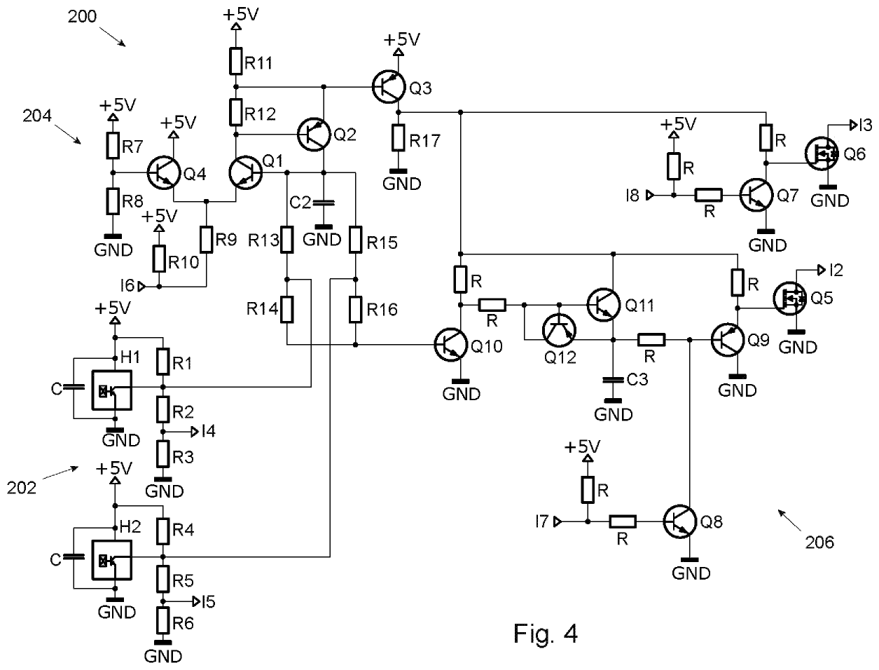

Turning attention to FIGS. 3 and 4, exemplary sections of a control system according to the present invention are shown at 100 and 200, respectively. Focusing specifically on FIG. 3, section 100 shows an electrical circuit configured to conduct electrical power to a motor. Section 100 of the exemplary control system includes an incoming electrical power terminal 102 and an outgoing power terminal 104. Incoming power terminal 102 is typically connected to a source of electrical power such as an electrical outlet through a suitable power cord (not shown). Similarly, outgoing power terminal 104 is typically connected to the power terminals of a motor by a suitable power cord (not shown). Section 100 of the exemplary control circuit operates to selectively conduct or transfer electrical power from the power source to the motor depending on various conditions and inputs as will be described.

As shown in FIG. 3, the neutral line from terminal 102 is directly connected to neutral line of terminal 104. In contrast, the active power or hot line from terminal 102 is connected to the hot line at terminal 104 through a mechanical power switch 106 and two normally OFF or open electrical relays 108 and 110. When switch 106, relay 108, and relay 110 are all closed, a circuit path will be created that allows electrical power to be transferred or conducted from terminal 102 to terminal 104 and thereby to the motor. In contrast, if any one or more of the switch or the relays is open, then electrical current cannot flow through the circuit to transfer power from terminal 102 to terminal 104.

In the exemplary embodiment, switch 106 is in the form of an electrical power switch that is manually operated by the user to supply or remove power to the circuit.

When the switch is in the OFF or open position electrical power does not flow or transfer through the switch. When a user moves the switch to the ON or closed position, then electrical power can flow through the switch. Thus, a user has direct physical control over the transfer of electrical power to the motor since no electrical power can transfer to terminal 104 when a user places switch 106 in the OFF position. In some embodiments, switch 106 may also function as a ‘Main Power Switch’ such that it supplies electrical power to multiple or even all sections of control system 12. In such embodiments, the user connects electrical power to turn ‘ON’ the control system by moving the Main Power Switch 106 to the ‘ON’ or closed position. As discussed above, switch 106 may be implemented in any of a variety of well-known forms such as rocker switches, pull-on buttons, knobs, trigger switches, etc. Alternatively, the switch may be any of the well-known electro-mechanical devices configured for selectively conducting electrical power such as magnetic contactor switches, etc.

As can be seen in FIG. 3, when switch 106 is closed or in the ‘ON’ position, electrical power is connected to the input of relay 108. The output of relay 108 is connected to the input of relay 110, and the output of relay 110 is connected to the hot line of terminal 104. A capacitor C1, configured for arc-suppression, is connected across relay 108 to reduce electrical arcing when the relay opens or closes. Capacitor C1 is not sized or otherwise configured to transfer electrical power to relay 110. Thus, electrical power can only be conducted or transferred to terminal 104 when both relay 108 and relay 110 are closed.

In the exemplary embodiment, both relay 108 and 110 are controlled, either directly or indirectly, by signals from one or more processors operating under software command.

Relay 108 is configured as a Make/Break relay whose magnetic coil is actuated or controlled by two processor-controlled input signals which are indicated at 11 and 12. Input signal 11 is provided by a first software-controlled processor while input signal 12 is provided by a second software-controlled processor. As a result, both processors must agree on whether the relay should be closed to conduct electrical power. If either processor does not send the correct signal to close the relay, then the relay will either remain open or it will transition to open if currently closed. It will be appreciated that while the exemplary embodiment includes two independent processors to control relay 108, the relay can alternatively be controlled by a single processor or more than two processors.

Relay 110 is configured as a Fail Safe relay and is controlled by a single processor input signal which is indicated at 13. Alternatively, relay 110 could be controlled by two or more processors which are the same as, or different from, the processors controlling relay 108. The purpose of Fail Safe relay 110 is provide a backup or redundant means for the processor to disconnect electrical power from the motor in the event that Make/Break relay 108 fails in a closed state. It is well known that the power contacts of relays can weld closed, for example due to electrical arcing, so that the relay is essentially always ON. In the event of such a failure of relay 108, the processor(s) would be unable to turn off the motor by signaling relay 108 to open. Therefore, relay 110 is provided as a redundant component to disconnect electrical power to terminal 104 and thereby stop the motor.

In the exemplary embodiment, relays 108 and 110 are operated so as to maximize the lifetime of the relays and to minimize the chances of welded contacts. Relay 110 is always closed first and opened last so that electrical current is typically not flowing when relay 110 opens and closes. This eliminates any electrical arcing on the contacts of relay 110. In contrast, relay 108 is always opened first and closed last which means that relay 108 is the relay which is actually switching electrical power on and off to the motor. Thus, any electrical arcing that occurs while turning the motor on and off will be isolated to relay 108. In some embodiments, the processors which control the operation of relay 108 may be configured to time the closing and opening of relay 108 so as to minimize arcing. This is accomplished by opening or closing relay 108 when the incoming AC power is at or near zero volts. In other words, the processors are configured to detect the zero-crossing point of the power and to open or close relay 108 at or near the zero-crossing point. In any event, if relay 108 does not open when the processor(s) send the signal to open, then electrical power will still be disconnected from the motor when relay 110 opens subsequently. The control of the Make/Break relay and the Fail Safe relay, including zero-crossing detection is described in more detail in U.S. Pat. No. 10,442,107, issued Oct. 15, 2019, the disclosure of which is incorporated herein by reference in its entirety.

Focusing attention now on section 200 of the control system as shown in FIG. 4, a portion of an exemplary control circuit is shown which is configured for receiving signals from a user input component and producing output signals for controlling relays 108 and 110 of FIG. 3. In summary, section 200 includes three subsections indicated generally at 202, 204 and 206. Subsection 202 includes circuitry configured to receive signals from a user input component, while subsection 204 includes circuitry configured to operate as a latch as described above. Subsection 206 includes circuitry to produce outputs that are connected as the processor input signals to relays 108 and 110 shown in FIG. 3. Each subsection is described in more detail below. It will be appreciated that the components and circuit configuration of FIG. 4 are just one exemplary embodiment for controlling a power tool and that many alternative assemblies of components and circuit configurations are possible within the scope of the present invention.

Control circuit subsection 202 includes two hall effect sensors H1 and H2 which are configured to detect the magnetic fields of two magnets when the magnets are in proximity to the hall effect sensors. In one exemplary embodiment which will be described in more detail below, the user input component includes two magnets which change position when the user moves the input component between ON and OFF or Start and Stop positions. Thus, hall effect sensors H1 and H2 are arranged to detect whether the input component is in the ON or OFF position based on the proximity of the magnets. When the input component is in the OFF position, the magnets are remote from the hall effect sensors and the output of each sensor is set to a tri-state or high-impedance output. In contrast, when the input component is in the ON position the magnets are near the hall effect sensors and therefore the output of each sensor is tied to ground. The exemplary embodiment uses dual magnets for redundancy and safety. Thus, as will be discussed, the mis-location of a single magnet or the failure of a single hall effect sensor will not cause an unexpected start of the motor. Nevertheless, it will be understood that alternative embodiments may employ different numbers and combinations of magnets and sensors. It will also be appreciated that different sensors and circuitry may be employed to detect the position of the user input component, such as microswitches, inductive proximity switches, reed switches, angular sensors, etc.

The outputs of hall effect sensors H1 and H2 are connected to voltage dividers formed by resistor network R1, R2, R3 and resistor network R4, R5, R6, respectively. The circuit nodes formed by R1-R2 and R4-R5 are connected as inputs to subsections 204 and 206. The circuit nodes formed by R2-R3 and R5-R6 are connected as inputs, indicated at I4 and I5, to one or more processors to signal the position of the user input component to the processors. The resistors in the resistor networks are configured so that, when the user input component is in the OFF position and thus the output of the hall effect sensors is high impedance, the voltage at nodes R1-R2 and R4-R5 is approximately 4-5V and the voltage at nodes R2-R3 and R5-R6 is approximately 2-3V or some other non-zero positive voltage suitable for input to the processors. In contrast, when the user input component is in the ON position and thus the output of the hall effect sensors is ground, the voltage at nodes R1-R2 and R4-R5 and also at nodes R2-R3 and R5-R6 is at or near ground. Thus subsection 202 is configured to sense the position of the user input component and signal that position to both subsections 204 and 206, as well as the one or more processors at inputs I4 and I5.

Subsection 204 of the exemplary control circuit includes two transistors Q1 and Q2 connected as a thyristor type latch, the output of which drives transistor Q3 which acts as a switch to produce an input signal to energize subsection 206. Transistor Q4, along with the voltage divider network of R7 and R8, functions as a voltage comparator with the input to Q1. Processor input I6, along with resistors R9 and R10 provide software control to either enable the latch or to reset it. When input I6 is set to either tristate or high voltage, the base/emitter junctions of both Q1 and Q4 will be reversed or unbiased and both transistors will be off. Thus, the processor is able to reset the latch by turning off Q1. Alternatively, when I6 is set to ground, either Q1 or Q4 will begin conducting current depending on the relative voltages at the base of each transistor. Thus, the processor enables the latch by setting I6 to ground. However, while the processor is configured to enable, disable and reset the latch through I6, it does not cause the latch to operate in the latched condition since the processor does not affect the base voltage of either Q1 or Q4. Instead, the voltage at the base of Q4 is set by the system voltage and resistor network R7-R8, while the voltage at the base of Q1 is controlled by the outputs of hall effect sensors H1 and H2, as will be described below.

When I6 is set to ground and the voltage at the base of Q1 is lower than the voltage at the base of Q4, then current will flow through Q4 but not Q1. However, once the voltage at the base of Q1 rises above the voltage at the base of Q4, then Q1 will begin to conduct current through the voltage divider formed by resistors R11 and R12. When current flows through Q1, the base/emitter junction of Q2 will become forward biased and Q2 will also turn on and begin to conduct current. Since the collector of Q2 is connected to the base of Q1, the current flow through Q2 will continue to supply current to the base of Q1, latching the transistor pair Q1 and Q2 in the “on” state. When both Q1 and Q2 are conducting current, the current feedback path between Q1 and Q2 operates to keep the transistors operating in the “on” state. In this operating situation, the two transistors are considered to be latched or operating in a latched condition. The electrical latch formed by Q1 and Q2 will continue to operate in the latched condition until power is removed from the circuit or until the processor resets the latch by setting I6 to tristate or high. When I6 is set to tristate or high, current will stop flowing through Q1 which will cause Q2 to turn off, thereby resetting the latch or causing it to operate in the unlatched condition. The latch will not transition from unlatched to latched operation until some signal causes the voltage at the base of Q1 to raise above the voltage at the base of Q4. As shown in FIG. 4, hall effect sensors H1 and H2 are connected to provide such a signal.

The hall effect sensors, which detect the position of the user input component, are connected to the base of Q1 through the dual resistor networks formed by R13, R14 and R15, R16. When the user input component is in the OFF position and the output of the hall effect sensors is set to tristate, then the voltages at nodes R1-R2 and R4-R5 exceed the threshold set by the divider network R7-R8. The resistor networks R13, R14 and R15 and R16 are configured to charge capacitor C2 and cause the voltage at the base of Q1 to be higher than the voltage at the base of Q4. In the exemplary embodiment, capacitor C2 is configured to cause a slight delay in raising the voltage at the base of Q1. This ensures sufficient time for the hall effect sensors to begin operating nominally when electrical power is initially applied to the control circuit.

If processor input I6 is set to ground when the user input component is in the OFF position, then I6 will enable the latch and Q1 will turn on once C2 charges to a voltage above the voltage at the base of Q4. Once Q1 turns on and begins to conduct current, Q2 will turn on and both Q1 and Q2 will latch as described above. Furthermore, once Q2 begins to conduct current, the collector of Q2 will maintain the voltage at the base of Q1 regardless of the outputs of the hall effect sensors. Thus, when the processor enables the latch and the user input component is set to OFF, the latch will begin operating in the latched condition and subsequent changes in the user input component or hall effect sensors will not directly affect operation of the latch.

In contrast, if the processor enables the latch when the user input component is in the ON position, then the hall effect sensors will detect the magnets and the outputs of the sensors will be set to ground. This causes the base of Q1 to be at ground thereby preventing it from turning on. As a result, the latch will operate in the unlatched condition. The latch will remain operating in the unlatched condition until the user input component is moved to the OFF position, at which point the voltage at the base of Q1 will rise and cause the latch to transition to the latched condition.

Thus, it will be seen that the operating condition and output of the latch will be determined by the combination and timing of the processor input signal I6 and the signals received from the user input component. The latch will not operate in the latched condition until both the processor enables the latch and the user input component is set to OFF. Only after these two events occur can the latch transition to the latched condition. Furthermore, the latch cannot transition to the latched condition solely under software command. While a software command by the processor can enable the latch at I6, the latch will transition from unlatched to latched only as a result of purely hardware inputs from the hall effect sensors. It will be appreciated that both hall effect sensors must agree that the user input component is in the OFF position. If the output of either hall effect sensor is at ground, indicating the proximity of a magnet and thereby signaling the user input component is in the ON position, then the base of Q1 will be held below the voltage at the base of Q4 and thereby prevent Q1 from turning on. As discussed above, a single magnet and sensor could alternatively be used if redundant sensors are not desired. Alternatively, dual sensors could be used to detect the position of a single magnet, in which case both sensors would have to agree before the latch could transition to latched operation.

The output of the latch is provided by transistor Q3 and is one of the inputs to control circuit subsection 206. When the latch is operating in the unlatched condition, current does not flow through either Q1 or Q2. As a result, the base of Q3 is essentially at 5V and base/emitter junction is not forward biased. In which case, current does not flow through Q3 so the voltage at the collector of Q3 is pulled to ground through resistor R17. Thus, when the latch is operating in the unlatched condition, the output of subsection 204 is a low or ground signal to subsection 206. In contrast, when the latch is operating in a latched condition, the voltage at the base of Q3 is pulled down and the base/emitter junction of Q3 becomes forward biased and Q3 turns on. Once Q3 is conducting current, the voltage at the collector of Q3 is pulled up. Thus, when the latch is operating in the latched condition, the output of subsection is a high signal of approximately 5V to subsection 206.

Focusing now on subsection 206 it will be seen that the output of subsection 206 is provided by the drain terminals of FET transistors Q5 and Q6, indicated at I2 and I3, respectively. When the gate inputs of either Q5 or Q6 is low or near ground, then the corresponding drain will be tristate or open circuit. In contrast, when the gate inputs of either Q5 or Q6 is high or above a turn-on threshold, then the corresponding transistor will begin to conduct and the drain will be pulled to ground. Referring briefly back to FIG. 3, it will be seen that I2 and I3 are connected to the control coils of relays 108 and 110, respectively. In particular, I2 provides one of the signals to relay 108 needed to turn on the relay and allow current to flow. The other signal is provided by the processor input I1. Thus, both I1 and I2 must agree (i.e., signal high and low values, respectively) for the relay to turn on. In contrast, I3 provides sole control over relay 110 since the other coil terminal of the relay is tied to 5V. Thus, when I3 is low, the relay will close or turn on to allow current to flow. As discussed above, in the exemplary embodiment depicted in FIGS. 3 and 4, relay 108 serves as the Make/Break relay while relay 110 serves as the Fail Safe relay. Therefore, I2 is considered the Make/Break relay enable signal while I3 is considered the Fail Safe relay control signal.

Focusing attention back on FIG. 4, it will be seen that additional safety redundancy is provided by processor controlled signals. Specifically, transistor Q5 is also controlled by processor signal I7 and transistor Q6 is also controlled by processor signal I8. Turning first to transistor Q6, it will be seen that the gate terminal of Q6 can be pulled low by transistor Q7. When 1I is low or ground, then the base junction of Q7 is also low and Q7 does not turn on. As a result, Q6 will turn on if it is enabled by the high output of the latch. However, if I8 is high then the base junction of Q7 will be forward biased and the transistor will pull the gate of Q6 to ground. This will be true regardless of the output from the latch. Thus, when Q6 is enabled by the latch, processor signal I8 turns on Q6 when I8 is low and turns off Q6 when I8 is high. It will be appreciated that the output of the latch and I8 must agree for Q6 to turn on and, thereby, turn on Fail Safe relay 110. In other words, the operation of Fail Safe relay 110 is controlled both by processor signal I8 and the latch. And as discussed above, the latch is controlled in turn by processor signal I6 and signals from the user input component as detected by hall effect sensors H1 and H2.

In summary, Fail Safe relay 110 can only turn or (or remain on) when the latch has first been enabled by I6 and then latched by positioning of the user input component to the OFF position. When this occurs, transistor Q6 is enabled, at which point processor signal I8 must turn on Q6 to pull I3 low and turn on relay 110. In the exemplary embodiment, the processor is configured to receive input signals I4 and I5, and to control signal I8 so as to only turn on Q6 when the user input component is in the ON position. Based on the description above, it will be understood that when power is first applied or restored to the control circuit, the user input component must first be placed in the OFF position so that the latch, once enabled, can transition to the latched condition. Once the latch is operating in the latched condition, Q6 is enabled. At this point, the user input component can be moved to the ON position and the processor signal I8 can turn on Q6, thereby turning on Fail Safe relay 110.

Turning now to Q5, it will be understood that the output from the latch operates to enable Q5 just as with Q6. Thus, the latch must be operating in the latched condition so as to provide enablement or enhancement voltage to the gate of Q5 before any control signal can cause Q5 to turn on. Similar to transistor Q6, transistor Q5 is under independent control of both hardware and software such that both or all signals must agree to turn on Q5. The software or processor signal is provided by I7, which operates similarly to processor signal I8. When I7 is low, the base junction of transistor Q8 will also be low and Q8 will not turn on. In this situation, Q8 will not affect the operation of Q9. However, when I7 is high or tristate, the base junction of transistor Q8 will be forward biased and Q8 will turn on. When Q8 is turned on and conducting current, the base junction of Q9 is forward biased and Q9 will turn on to pull the gate of Q5 to ground. Thus, when processor input I7 is high or tristate Q5 is turned off and the Make/Break relay is off.

As mentioned above, Q5 is controlled by hardware as well as the software which determines processor signal I7. The hardware control is provided by the user input component through hall effect sensors H1 and H2. The base junction of transistor Q10 is connected to the outputs of H1 and H2 through resistors R14 and R16, respectively. When the user input component is in the ON position and both H1 and H2 sense the magnets of the user input component, then the outputs of H1 and H2 are at ground and the base junction of Q10 is also at ground. Thus, Q10 will be off and Q11 will turn on to charge capacitor C3 to a positive voltage sufficient to turn off Q9 and allow Q5 to turn on. In contrast, if either H1 or H2 detects that the user input component is in the OFF position, then the output of that hall effect sensor will tristate and the 5V supply will turn on Q10 through resistor networks R1-R14 and/or R4-R16. If Q10 is on due to a detected OFF position of the user input by either hall effect sensor, the combined operation of Q10, Q12 and Q9 will prevent Q5 from turning on and thus prevent the Make/Break relay from closing. Additionally, once Q10 begins to conduct, any residual charge on C3 will cause Q12 to turn on and discharge C3 to turn on Q9 and further pull down the gate voltage of Q5. Thus, it will be seen that the hall effect sensors are configured to turn off Q5, and thereby the Make/Break relay 108, independent of any software control or command at processor signal 17.

In summary, when considering the Make/Break relay signal I2 from subsection 206, it will be seen that three conditions must be met to send a signal I2 that will enable the Make/Break relay to turn on. The first condition is that the latch must be operating in the latched condition so that the output from subsection 104 is a positive voltage that can enable the gate of Q5. The second condition is that processor signal I7 must be at ground or low to turn off Q8. The final condition is that both hall effect sensors must detect the user input component to be in the ON position so that Q10 is turned off. If any of the three conditions just described are not met, then Q5 will be off and I2 will not enable the Make/Break relay. It will be further appreciated that this configuration of control circuit section 200 provides safe and redundant control over the motor since both the processor signals and the hardware signals must agree to start the motor. And since the hardware signals of the latch and hall effect sensors are enabled independently of any software command or control, a fault or defect in the software or processor will not cause the motor to start unexpectedly. Furthermore, if electrical power is unexpectedly removed from the control circuit and then restored, the hardware signals of the latch will not enable Q5 and Q6, and therefore will prevent relays 108 and 110 from turning on even if the user input component is in the ON position and the processor(s) are signaling to turn on the motor.

While the exemplary control circuits shown in FIGS. 3 and 4 are one embodiment of the present invention, it will be appreciated by those of skill in the art that similar safe and redundant control of the power tool motor can be implemented with a wide variety of alternative circuit components and configurations, and the present invention is not limited to the exemplary embodiment but includes all such alternatives. Furthermore, as discussed above, control circuit subsections 100 and 200 may be incorporated in a larger control system with additional functions, including AIM technology, to provide additional and/or redundant safety for the operation of the power tool.

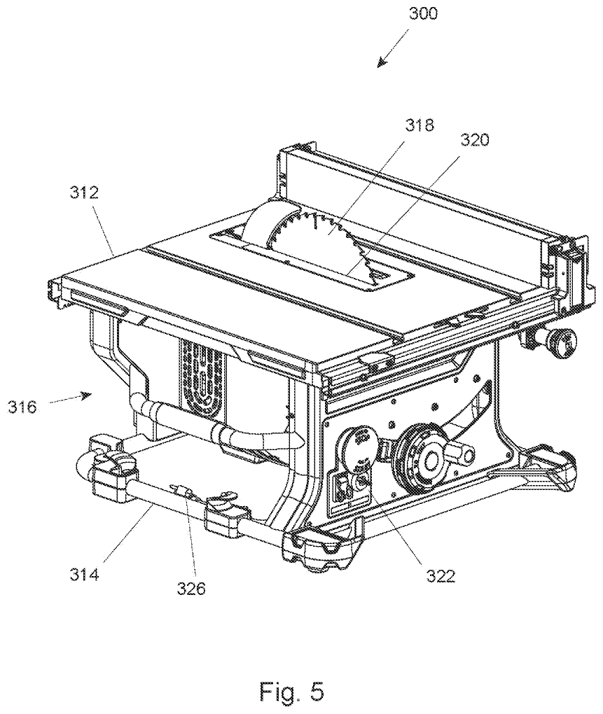

As discussed above, power tool 10 can take any of a variety of well-known forms and the control systems shown in FIGS. 1-4 and described above may be implemented as part of any of these various power tools. As just one example of a power tool according to the present invention, FIG. 5 shows a power tool in the form of a compact table saw which is indicated generally at 300.

Table saw 300 includes a table or support surface 312 attached to, and supported by a support structure 314 which, in this embodiment, is in the form of a metal frame. The support structure can alternatively be in many other forms such as a housing, cabinet, etc. Frame 314 also supports and at least partially encloses an internal mechanism, indicated generally at 316, including an electrically-driven motor that is operably coupled to a cutter or cutting tool such as saw blade 318. In the present embodiment saw blade 318 is a standard circular saw blade adapted for use on a table saw and includes a plurality of cutting surfaces or edges or teeth disposed or spaced about the perimeter of the blade. The internal mechanism includes an assembly of mechanical components such as trunnions, gears, shafts, bearings, brackets, linkages, handles, knobs, handwheels, etc., that allow the user or operator to raise and lower the blade through an opening 320 in the table. The user can process or cut a material such as wood by placing the wood on the table and moving the wood into contact with the blade while the blade is rotationally-driven, or otherwise movably-driven, by the motor. Other forms of power tools may include different mechanisms and components adapted to perform different processing operations on a workpiece or different kinds of workpieces, but all generally include some type of motor-driven cutter.

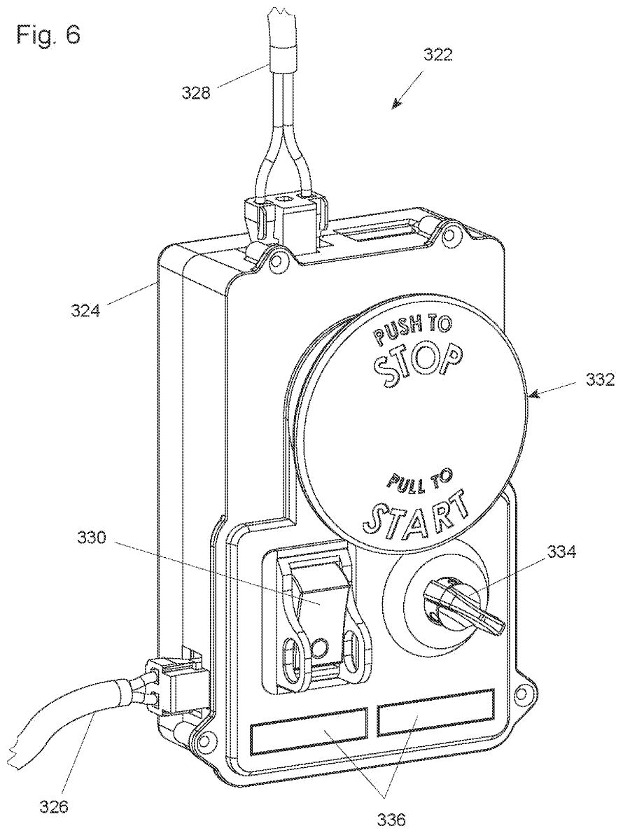

According to one embodiment of the present invention, table saw 300 includes a user interface module in the form of a switch box 322, shown generally in FIG. 5 and in more detail in FIG. 6. Switch box 322 includes a housing or enclosure 324 for electrical and mechanical components adapted and arranged for operating the saw. One or more openings in housing 324 allow the pass-through of wires, cords or cables to conduct electrical power or information to and from the switch box. In the embodiment depicted in FIG. 6, switch box 322 is configured to connect to a source of electrical power by a power cord 326 while also to connecting to a motor via a separate cable 328. As a result, switch box 322 is operable to supply electrical power to a motor. It will be understood that in alternative embodiments, switch box 322 may be connected to different or additional cables to send and receive input/output signals and etc. As a further alternative, switch box 322 could be connected wirelessly to transfer either power or data through well-known protocols such as NFC, Bluetooth, wireless charging, etc.

In some embodiments of the present invention, switch box 322 also includes one or more user input components that are operable by a user to control the power tool. As discussed above, such components may include any of the well-known user-operable components such as buttons, switches, knobs, keyboards, touch pads, touch screens, key locks, levers, toggles, etc. Additionally, the switch box may include one or more indicator components such as lights, LEDs, screens, audio devices, etc., which operate to indicate information about the power tool to the user such as the operating status, functional state, etc. Alternatively, the user may interact with the switch box through other means such as wireless communication through a smart phone app, smart speaker, etc. In any case, the switch box is configured to allow the user to control at least some functions of the power tool and/or receive at least some information regarding the status or function of the power tool.

In the exemplary embodiment shown in FIG. 6, switch box 322 includes three user-operable input components: a main power switch 330, a motor start/stop switch 332, and a bypass switch 334. The exemplary switch box also includes two indicator components 336 which are configured to indicate various status and functional conditions of the table saw.

Switch box 322 contains electrical components that are powered by a source of electricity supplied through power cord 326. In the exemplary embodiment, a portion of control system 12 is enclosed within switch box 322. However, in alternative embodiments the control system may be entirely enclosed within the switch box or the power tool may include multiple housings, each of which enclose some portion of the control system.

To enable operation of the table saw, the user plugs the opposite end (shown in FIG. 5) of power cord 326 into a suitable outlet for electrical power. In the present embodiment, electrical power is supplied through power cord 326 to main power switch 330. When the main power switch is in the OFF or open condition, the electrical power is not conducted through the switch. When the user wishes to supply power to the switch box, the user moves the toggle button to the ON position and this causes the main power switch to close. When the main power switch is in the ON position or closed condition, then electrical power, if present, can be conducted through the switch. In the exemplary embodiment shown in FIG. 6, main power switch 330 functions as the mechanical switch 106 of control circuit subsection 100 as shown in FIG. 3. However, it will be appreciated that switch 330 may be configured to perform different functions in other embodiments within the scope of the invention.

Motor start/stop switch 332 is in the form of a push-pull button or paddle style switch whereby the user pushes the switch toward housing 324 to signal the user wants to stop the motor, or the user pulls the switch away from housing 324 to signal the user wants to start the motor. Thus, when the switch is pushed in, the switch is in the OFF or Stop position, and when the switch is pulled out, it is in the ON or Start position. The particular configuration of switch 332 promotes safe operation since it is difficult to accidentally pull the switch to the ON position. Furthermore, it is very easy for a user to push the relatively large surface of the switch inward to the OFF position to stop the motor.

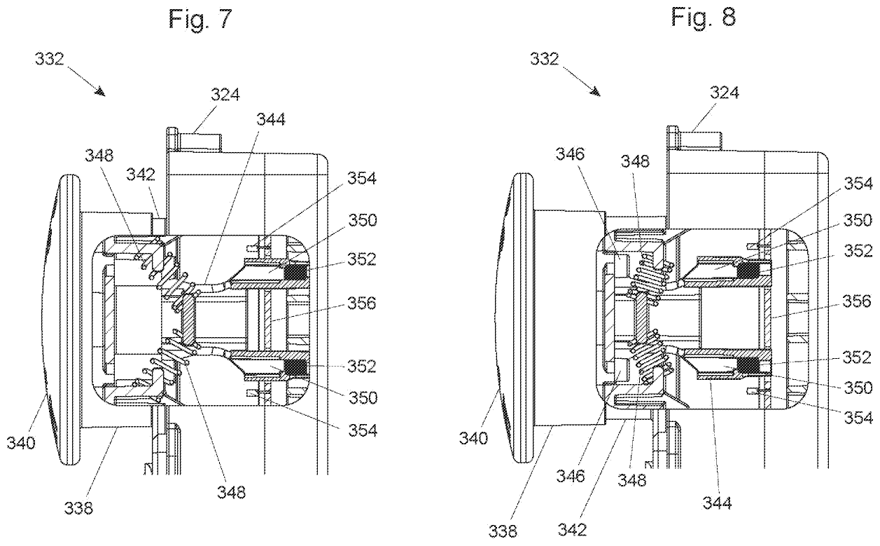

Turning attention now to FIGS. 7 and 8, details of how switch 332 is coupled to the exemplary control circuit are shown. As can be seen in the partial cut-away, cross-sectional views, the switch includes a generally cylindrically shaped interface component 338 which is positioned on the front exterior of switchbox housing 324 and includes a paddle or button surface 340 facing away from the housing. Component 338 is constrained to move in a generally axial direction by a generally cylindrical guide surface 342 formed in housing 324. Switch 332 also includes a carrier component 344 which is constrained within housing 324, but which is attached to component 338 by screws 346 so that the carrier component moves with the interface component. Thus, it will be seen than when interface component is in the OFF position as shown in FIG. 7, the carrier component is positioned more deeply into housing 324. In contrast, when the interface component is in the ON position as shown in FIG. 8, the carrier component is positioned less deeply in housing 324.

In the exemplary embodiment, the interface component is movable by a user from the OFF position to the ON position, and vice versa. The switch box includes two compression springs 348 which engage a portion of carrier component 344 and internal structures of housing 324. The springs operate to maintain the interface and carrier components in the position the user selects. As the interface and carrier components are moved between the ON and OFF positions, the springs compress. Once the interface and carrier components are near either the ON or OFF position, the springs begin to expand and push the carrier component to the new position. Thus, the configuration of the springs can be thought of having dual stable positions or as operating in an over-center fashion. It will be appreciated that the springs are selected so as to apply sufficient force to hold the components in position, but not so much force as to prevent the user from moving the components to the desired position. While dual compression springs are shown in the exemplary embodiment, either a single spring or more than two springs could alternatively be used to achieve the desired operation.

The end of carrier component 344 that is opposite the interface component includes two cavities 350 configured to hold a magnet 352 in each cavity. When the carrier component moves within the switch box housing, the magnets also move as can be seen by comparing FIGS. 7 and 8. As the magnets move inside the housing, they pass near two hall effect sensors 354 which are mounted on a pc circuit board 356. The pc board includes holes through which the carrier component and magnets pass. It will be understood that hall effect sensors 354, which are shown in FIGS. 7 and 8, correspond to hall effect sensors H1 and H2 which are shown in FIG. 4. In addition, pc circuit board 356 is configured to contain at least a portion of control circuit 200.

From the description of Start/Stop switch 332 above, it will be appreciated that switch 332 is operable by a user to signal to the control circuit the user's intent to either start or stop the motor. When the user places the switch in the OFF position as shown in FIG. 7, magnets 352 are remote from hall effect sensors 354 so that the sensors either do not detect the magnetic field of the magnets, or detect a magnet field that is below the sensor's threshold to output a ground signal. Thus, a Stop or OFF signal is transmitted to the control circuit. However, when the user places the switch in the ON position, the magnets are close to the sensors which then detect the magnetic fields and output a ground signal to the control circuit as described above. Thus, a Start or ON signal is transmitted to the control circuit.

It will be understood that while the exemplary embodiment of FIGS. 7 and 8 includes two magnets and two hall effect sensors for redundancy and fail-safe operation, alternative configurations may be employed within the scope of the invention to achieve equivalent results. For example, a single magnet may move past two hall effect sensors, which both must sense the magnetic field to register a Start signal from the user. Alternatively, one hall effect sensor could be positioned to detect the magnetic field when the switch is in the ON position, and a second hall effect sensor could be positioned to detect the magnetic field when the switch is in the OFF position. In which case, the control circuit could require opposite outputs from the hall effect sensors to register a valid user input signal. Many other configurations and combinations are also possible within the scope of the invention.

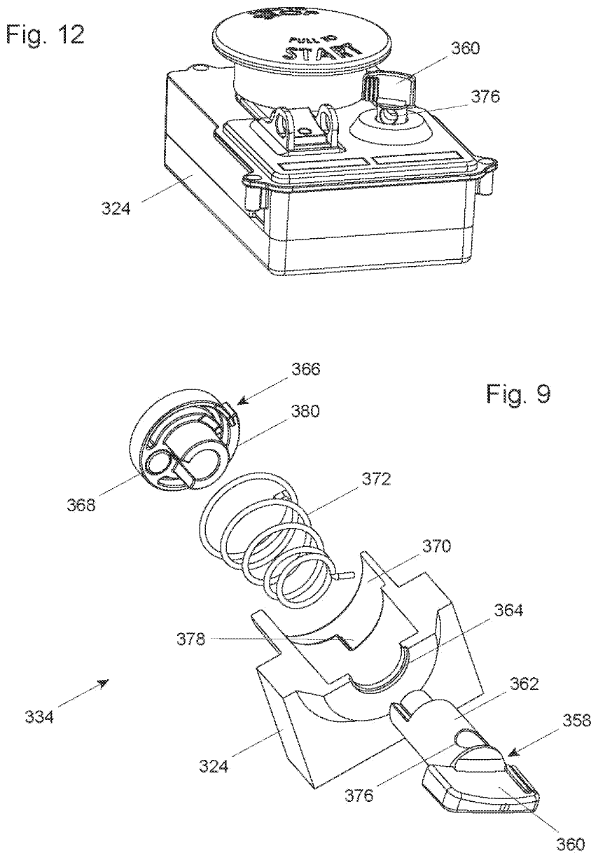

Turning attention now to FIGS. 9-12, the details of bypass switch 334 are shown. In the exemplary embodiment of FIG. 5, table saw 300 includes an AIM system configured to detect dangerous contact between a person and saw blade 318, and then react to mitigate injury to the user by stopping the blade from cutting. Since there are some operations of the table saw for which the user may wish to disable or disengage or deactivate the AIM system, bypass switch 334 functions as a user input component for the user to signal to the AIM system the user's intention to disable injury mitigation.

Focusing first on FIG. 9, it will be seen that the bypass switch has an interface component 358 with a generally flat handle section 360 and a generally cylindrical shaft section 362. While interface component 358 takes the general shape of a key in the exemplary embodiment, it will be appreciated that alternative embodiments may take other forms as are known to those of skill in the art. In the exemplary embodiment, the shaft section 362 of the key is constrained to slide and rotate within a generally cylindrical opening 364 in switch box housing 324. However, the handle section 360 remains outside of housing 324 so as to be operable by a user.

The bypass switch also has a carrier component 366 that is connected to interface component 358 by a screw (not shown). Carrier component 366 is generally disk-shaped and contains a cavity to hold a magnet 368. The carrier component is constrained to slide and rotate within a generally cylindrical structure 370 of housing 324. Furthermore, the shape of structure 370 is configured to limit the travel of carrier component 366 in both the axial and rotational directions. In other words, structure 370 includes stops or abutments against which the carrier is prevented from further travel. In the exemplary embodiment, structure 370 limits the rotation of carrier 366 to approximately 90 degrees of rotational travel and a few centimeters of axial travel. It will be appreciated that structure 370 could alternatively be configured to provide different degrees of constraint within the scope of the invention.

Bypass switch 334 also includes a torsion spring 372 disposed around cylindrical section 362 and between carrier component 366 and the inside surface of housing 324. Torsion spring 372 is configured to engage structures on the carrier component and housing to provide axial (compressive) and rotational (torsional) biasing to the interface and carrier components, relative to the housing. Specifically, the spring biases the interface and carrier components deeper into the housing and counter-clockwise to the housing. However, while the spring is selected to provide sufficient force to hold handle section 360 in one position, the force is not so large as to prevent the user from moving the bypass switch to a second position. In the present embodiment, spring 372 is configured to bias and hold the bypass switch in the OFF or disabled position, while the user can move the bypass switch into either of two other positions, referred to herein as the On or enabled position and the Lockout position.

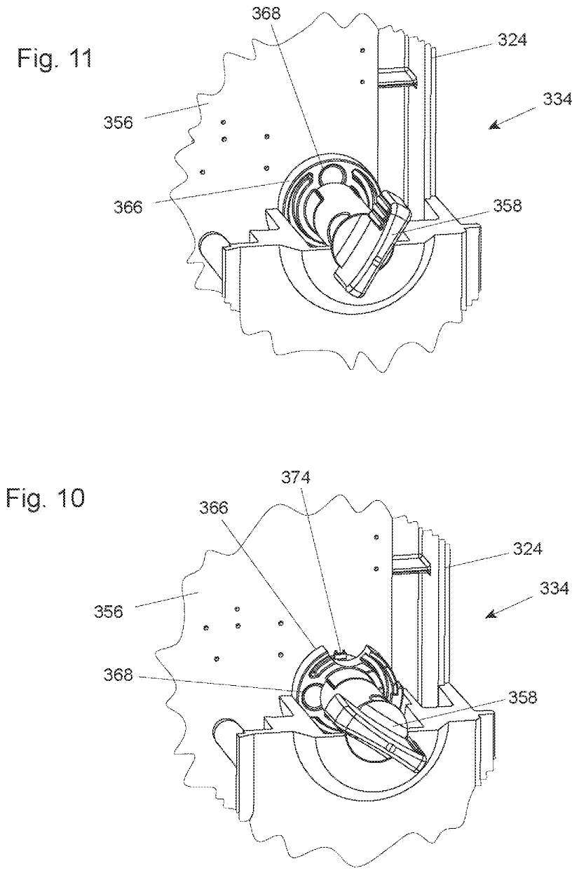

Focusing now on FIG. 10, bypass switch 334 is shown in the OFF or disabled position. In the view shown in FIG. 10, spring 372 has been removed and carrier component 366 has been partially cut away to show a hall effect sensor 374 mounted on pc board 356. The bypass key switch is shown in the counter-clockwise or OFF position where magnet 368 is rotated away from the hall effect sensor sufficiently so that the sensor does not detect sufficient magnetic field strength from the magnet to turn on or sense the magnet's proximity. However, when a user rotates the bypass key approximately 90 degrees clockwise to the ON position, as shown in FIG. 11, then magnet 368 is rotated over the hall effect sensor so that the magnetic field detected by the sensor is strong enough to turn on the sensor or to sense the magnet's proximity. As discussed above, the user must rotate the bypass key against the torsional biasing of spring 372, and when the user releases the bypass key the spring will cause the bypass key to rotate back in a counter-clockwise direction to the OFF position.

It will be understood from the discussion above that bypass switch 334 is an alternative user input component within the scope of the invention. A user operates the bypass switch to send operating signals to the control circuit when the user wishes to bypass or disable or disengage the AIM system. The control circuit is configured to receive those signals through hall effect sensor 374 similar to the motor Start/Stop switch described above. The control circuit typically will receive such signals and either execute them or signal an error condition depending on the overall configuration of the control system.

In some embodiments of switch box 322, bypass switch 324 may be disabled or locked-out to prevent users from bypassing the AIM system. As shown in FIG. 12, a user may pull handle section 360 outward away from housing 324 and against the compressive bias of spring 372. When the handle section is pulled out, a hole 376 in the handle section is exposed outside the switch box housing. If desired, the user can place a standard pad lock or similar locking device through hole 376 to prevent the spring from returning the handle portion to its nominal position against the housing. As shown in FIG. 9, structure 370 includes a recess section 378 configured to accept a ridged section 380 on carrier component 366. Thus, when the bypass key is in the OFF position, the ridged section is aligned with the recess section so that the bypass key can be pulled outward by the user. When the key is pulled outward, the engagement of the ridged section and the recess section prevents the key from being rotated to the ON position. Additionally, the entire carrier component is raised away from the pc board and the hall effect sensor, which further ensures the sensor cannot detect the magnetic field of the magnet. As a result, it is not possible for any user to bypass the AIM system while the bypass key is held in this Lockout position.

### INDUSTRIAL APPLICABILITY

The control systems and power tools described herein are applicable to woodworking, manufacturing, packaging, construction, carpentry, material processing, etc. Various disclosed features are particularly relevant to control systems for table saws and control systems for power tools with active injury mitigation technology.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. No single feature, function, element or property of the disclosed embodiments is essential to all of the disclosed inventions. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

1. A power tool comprising:
a movable cutter adapted to cut a workpiece when the cutter is moving;
an electrically-powered motor coupled to move the cutter;
one or more user-input components operable by a user to selectively generate a first user input signal and a second user input signal; and
an electrical control circuit connected to receive the first and second user input signals from the one or more user-input components, where the electrical control circuit is configured to connect to a source of electrical power, and to selectively start or stop the motor;
where the control circuit includes:
an electrical power switching circuit configured to connect and disconnect the source of electrical power to the motor in response to one or more motor control signals,
a processor configured, under the control of software instructions, to receive the first and second user input signals, and to start and stop the motor by transmitting at least one motor control signal to the electrical power switching circuit to connect and disconnect electrical power to the motor, and
an electrical latch circuit configured to detect if the control circuit is disconnected from the source of electrical power, and to prevent the processor from starting the motor when the control circuit is reconnected to the source of electrical power until the one or more user-input components generates the first user input signal followed by the second user input signal, where the latch circuit is configured to prevent the processor from starting the motor irrespective of the software instructions.

2. The power tool of claim 1, where the electrical latch circuit prevents the processor from starting the motor by preventing the electrical power switching circuit from receiving a motor control signal from the processor to start the motor.

3. The power tool of claim 2, where the electrical latch circuit enables the electrical power switching circuit to receive a motor control signal from the processor to start the motor after the one or more user-input components generates the first user input signal.

4. The power tool of claim 1, where the one or more user-input signals is operable by a user to generate the first user input signal when the user wishes to stop the motor and the second user input signal when the user wishes to start the motor.

5. A power tool comprising:
a movable cutter adapted to cut a workpiece when the cutter is moving;
an electrically-powered motor coupled to move the cutter;
at least one user-interface device operable by a user to output user-selected signals including a first signal to stop the motor and a second signal to start the motor; and
an electrically-powered control circuit including,
at least one switch adapted to conduct electrical power to the motor when the switch is closed;
at least one software-controlled processor coupled to receive the signals from the at least one user-interface device and to cause the switch to open and close;
an electronic latch configured to operate in a first state when electrical power to the control system is restored after being removed, where the latch prevents the switch from closing while the latch is operating in the first state, and where the latch circuit will continue to operate in the first state, notwithstanding any software command, until the user-interface device outputs the first signal.

6. The power tool of claim 5, where the electronic latch is configured to begin operating in a second state if the user-interface device outputs the first signal followed by the second signal while the electronic latch is operating in the first state, and where the electronic latch does not prevent the switch from closing while the latch is operating in the second state.

7. The power tool of claim 6, where the electronic latch is configured to continue operating in the second state until electrical power is removed from the control circuit independent of any subsequent signals which the at least one user interface device outputs.

8. The power tool of claim 5, further comprising an active injury mitigation system configured to detect contact between a person and the cutter, and to stop the cutter from cutting if contact between a person and the cutter is detected while the cutter is moving.

9. A power tool comprising:
a movable cutter adapted to cut a workpiece when the cutter is moving;
an electrically-powered motor coupled to move the cutter;
a control system adapted to connect to a source of electrical power, and including a processor that is programmed by software to start and stop the motor;
one or more components configured so that, when the control system is connected to a source of electrical power, the one or more components are operable by a user to signal a request to the processor to start and stop the motor; and
electronic latch means for preventing the processor from starting the motor unless the one or more components are operated by the user to signal the processor to stop the motor prior to signaling the processor to start the motor.
